(19) United States
(12) Patent Application Publication
(10) Pub. No.: US 2018/0366837 A1
(43) Pub. Date: Dec. 20, 2018

(54) EFFICIENT PLANAR PHASED ARRAY ANTENNA ASSEMBLY

(71) Applicants: Urthecast Corp, Vancouver (CA); King Abdulaziz City of Science and Technology, Riyadh (SA)

(72) Inventors: Peter Allen Fox, Burnaby (CA); Abhijit Bhattacharya, Burnaby (CA); Ying Chen, Richmond (CA); Rodney Grant Vaughan, Burnaby (CA)

(21) Appl. No.: 15/737,065

(22) PCT Filed: Jun. 15, 2016
(86) PCT No.: PCT/US2016/037666

§ 371 Date: Dec. 15, 2017

Related U.S. Application Data
(60) Provisional application No. 62/180,421, filed on Jun. 16, 2015.

(51) Int. Cl. H01Q 21/06; H01Q 13/18; H01Q 21/00; H01Q 5/42; H01Q 21/30

(52) U.S. Cl. CPC H01Q 21/064; H01Q 13/18; H01Q 21/30; H01Q 5/42; H01Q 21/005

(57) ABSTRACT

A planar phased array antenna assembly includes a first face sheet with a first plurality of radiating slots for a first frequency band and a second plurality of radiating slots for a second frequency band, a second face sheet, a third face sheet, and a structure interposed between the first and second face sheets with a third plurality of radiating elements at the first frequency band and a fourth plurality of radiating elements at the second frequency band, and a first feed network for the third plurality of radiating elements and a second feed network for the fourth plurality of radiating elements, and the second face sheet interposed between the structure and the third face sheet. The planar phased array antenna assembly may form part of a synthetic aperture radar (SAR) antenna.

### BACKGROUND

### Technical Field

The present application relates generally to phased array antennas and, more particularly, to efficient phased array antennas suitable for dual band synthetic aperture radar.

### INTRODUCTION

A multi-frequency, multi-polarimetric synthetic aperture radar (SAR) is desirable but the limitations of payload, data rate, budget, spatial resolution, area of coverage, and so on, present significant technical challenges to implementing a multi-frequency, fully polarimetnc SAR especially on spaceborne platforms.

The Shuttle Imaging Radar SIR-C is an example of a SAR that operated at more than one frequency band. The two antennas did not share a common aperture, however, and the mass was too large for deployment on the International Space Station (ISS) or on a SmallSAT platform.

An antenna configuration, especially on a spaceborne platform, can be constrained for various reasons in area and thickness. For example, the physical limitations of the launch vehicle can impose constraints on the sizing of the antenna. A constraint on the area of the antenna can, in turn, place a constraint on directivity. For this reason, efficiency can be a major driver of antenna design, and finding ways to reduce antenna losses can become important.

Existing approaches to the design of multi-frequency phased array antennas can include the use of microstrip arrays. These can be associated with high losses and consequently low efficiency.

The technology described in this application relates to the design and build of a cost-effective, high-efficiency, structurally-sound SAR antenna suitable for ISS and SmallSAT deployment, constrained by thickness and with dual frequency operation and full polarization on at least one frequency band.

In addition to the need for low profile, high-efficiency radar antennas, there is a similar need for commercial microwave and mm-wave antennas such as in radio point-to-point and point-to-multipoint link applications. Typically, a reflector antenna is used for these applications. However, the reflector and feed horn together present a considerable thickness.

One lower-profile alternative is the microstrip planar array. Several layers are often required and special arrangements are sometimes necessary to prevent parallel plate modes from propagating between different layers. These characteristics together with the cost of low-loss materials and the supporting structure make the approach less attractive. It is also difficult to reduce the losses for a microstrip array, especially at high frequencies. So, while the use of a microstrip array can reduce the thickness of the antenna, the antenna is lossy and the area of the antenna needs to be larger than a reflector antenna to achieve the same gain.

### BRIEF SUMMARY

A planar phased array antenna assembly may be summarized as including a first face sheet, the first face sheet comprising a first plurality of radiating slots for a first frequency band and a second plurality of radiating slots for a second frequency band; a second face sheet; a structure interposed between the first face sheet and the second face sheet, the structure comprising a third plurality of radiating elements at the first frequency band and a fourth plurality of radiating elements at the second frequency band, the structure further comprising a first feed network for the third plurality of radiating elements and a second feed network for the fourth plurality of radiating elements: and a third face sheet wherein the second face sheet is interposed between the structure and the third face sheet.

The assembly may be structurally self-supporting. Substantially the entire assembly may consist of radiating elements and feed networks. The first face sheet, the second face sheet, the third face sheet, and the structure may each include machined aluminium. Each of the third plurality of radiating elements may include a folded cavity coupled to at least one of the first plurality of radiating slots. Each of the fourth plurality of radiating elements may include at least one waveguide coupled to at least one of the second plurality of radiating slots, and the third face sheet may include waveguide terminations. Each of the at least one waveguide may be a ridged waveguide. The first frequency hand may be L-band and the second frequency hand may be X-band. The first feed network may include at least one stripline, and at least one probe coupled to each of the third plurality of radiating elements. The second feed network may include at least one coaxial cable coupled to each of the fourth plurality of radiating elements. The first plurality of radiating slots may include a plurality of crossed slots, the crossed slots operable to radiate horizontally polarized and vertically polarized microwaves. The plurality of crossed slots may be flared in at least one of an in-plane and a through-plane orientation. The folded cavity may be at least partially filled with dielectric material. The first, the second and the third face sheets and the structure interposed between the first and the second face sheets may include a sole support structure of the planar phased array antenna assembly that self supports the planar phased array antenna assembly without any additional structure.

A synthetic aperture radar (SAR) antenna may include the planar phased array antenna assembly.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is an exploded isometric view of an efficient planar phased array antenna assembly, according to at least a first illustrated embodiment.

FIG. 2 is a front plan view of a portion of the first face sheet of the efficient planar phase array antenna assembly of FIG. 1.

FIG. 3 is an isometric view of a microwave subarray of the efficient planar phase array antenna assembly of FIG. 1.

FIG. 4 is an exploded isometric view of the microwave subarray of FIG. 3.

FIG. 5 is a close-up of a front plan view of the microwave subarray of FIG. 3 with a top face sheet removed.

FIG. 6 is an isometric partial view of a close-up of the microwave subarray of FIG. 3 with a side removed to show the L-band cavity.

FIG. 7 is a cross-sectional view of an L-Band radiating element illustrating an L-band feed network.

FIG. 8 is a cross-sectional view of an X-band radiating element illustrating an X-band feed network.

FIG. 9 is an isometric view of a microwave subarray of an efficient planar phase array antenna assembly, according to at least a second illustrated embodiment.

FIG. 10 is an exploded isometric view of the microwave subarray of FIG. 9.

FIG. 11 is an isometric view of a close-up of the microwave subarray of FIG. 9 with a side removed to show the L-band cavity.

FIG. 12 is a polar plot showing a gain for an L-band radiating element of the efficient planar phase array antenna assembly of FIG. 9.

FIG. 13 is a polar plot showing a gain for an X-band radiating element of the efficient planar phase array antenna assembly of FIG. 9.

FIG. 14 is an impedance Smith chart for an L-band radiating element of the efficient planar phase array antenna assembly of FIG. 9.

### DETAILED DESCRIPTION

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The Abstract of the Disclosure provided herein is for convenience only and does not interpret the scope or meaning of the embodiments.

In a conventional antenna assembly, the radiating elements are typically mounted on a structural subassembly such as an aluminium honeycomb sheet. The structural subassembly contributes to the overall mass and volume of the antenna assembly without enhancing the electromagnetic performance.

The radiating elements are typically not self-supporting and are mounted to the structural subassembly. The radiating elements often comprise dielectric materials which, in combination with dielectric materials used to attach the radiating elements to the structural subassembly, can result in significant antenna losses.

Using conventional technology, a multi-frequency antenna can be implemented using patch elements. Such patch elements are sometimes layered or stacked, and are perforated to allow a smaller radiating element to radiate through a larger radiating element, for example an X-band radiating element radiating through an L-band radiating element.

In the present approach, the microwave structure comprises radiating elements in one or more subarrays, and does not require a separate structural subassembly. The microwave subarrays can be self-supporting and configured so that the radiating elements of the microwave subarrays serve also as structural elements.

Furthermore, a multi-frequency antenna assembly can be arranged to integrate radiating elements for two hands (such as X-band and L-band) into a common aperture. For example, X-band slot or patch radiating elements can be placed in the spaces between L-band slots.

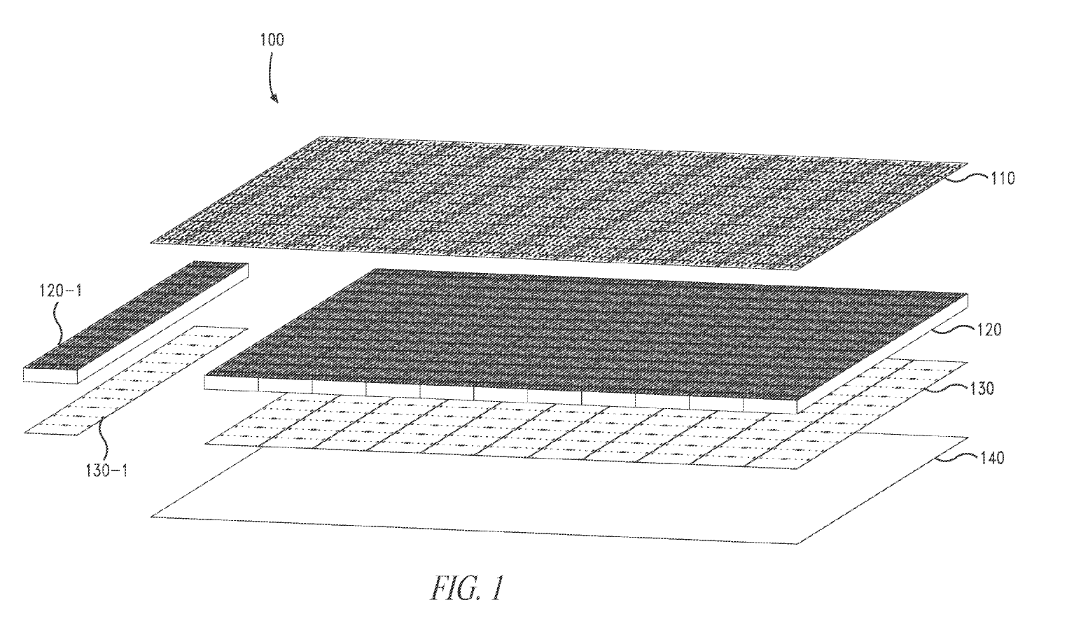

FIG. 1 shows an efficient planar phased array antenna assembly 100, according to at least a first illustrated embodiment. The size of antenna assembly 100 can be tailored to meet the gain and bandwidth requirements of a particular application. An example application is a dual-band, dual-polarization SAR antenna. In an example implementation of a dual-band, dual-polarization SAR antenna, assembly 100 is approximately 2.15 m wide, 1.55 m long and 50 mm deep, and weighs approximately kg.

Antenna assembly 100 is an example of a dual-band (X-band and L-band), dual-polarization (H and V polarizations at L-band) SAR antenna assembly. While embodiments described in this document relate to dual X-band and L-band SAR antennas, and the technology is particularly suitable for space-based SAR antennas for reasons described elsewhere in this document, a similar approach can also be adopted for other frequencies, polarizations, configurations, and applications including, but not limited to, single-band and multi-band SAR antennas at different frequencies, and microwave and mm-wave communication antennas.

Antenna assembly 100 comprises a first face sheet 110 on a top surface of antenna assembly 100, containing slots for the L-band and X-band radiating elements (shown in detail in subsequent figures).

Antenna assembly 100 comprises microwave structure 120 below first face sheet 110. Microwave structure 120 comprises one or more subarrays such as subarray 120-1, each subarray comprising L-band and X-band radiating elements. The radiating elements are described in more detail below.

Microwave structure 120 is a metal structure that is self-supporting and does not require a separate structural subassembly. Microwave structure 120 can be machined or fabricated from one or more metal blocks, such as aluminium blocks or blocks of another suitable conductive material. The choice of material for microwave structure 120 determines, at least in part, the losses and therefore the efficiency of the antenna.

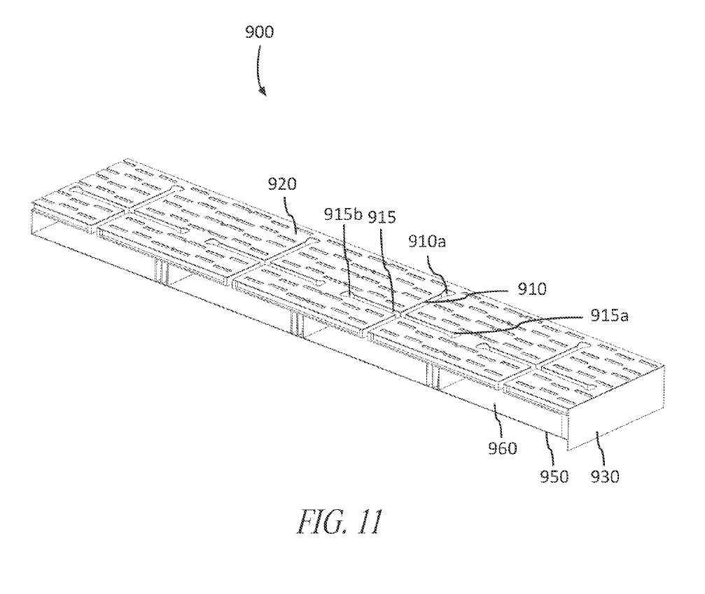

Antenna assembly 110 comprises second face sheet 130 below microwave structure 120, second face sheet 130 closing one or more L-band cavities at the hack. The L-band cavities are described in more detail below in reference to FIG. 11.

Antenna assembly 110 comprises third face sheet 140 below second face sheet 130, third face sheet 140 comprising waveguide terminations. Third face sheet 140 also provides at least partial structural support for antenna assembly 110.

In some implementations, antenna assembly 110 comprises a multi-layer printed circuit board (PCB) (not shown in FIG. 1) below third face sheet 140, the PCB housing a corporate feed network for the X-band and L-band radiating elements.

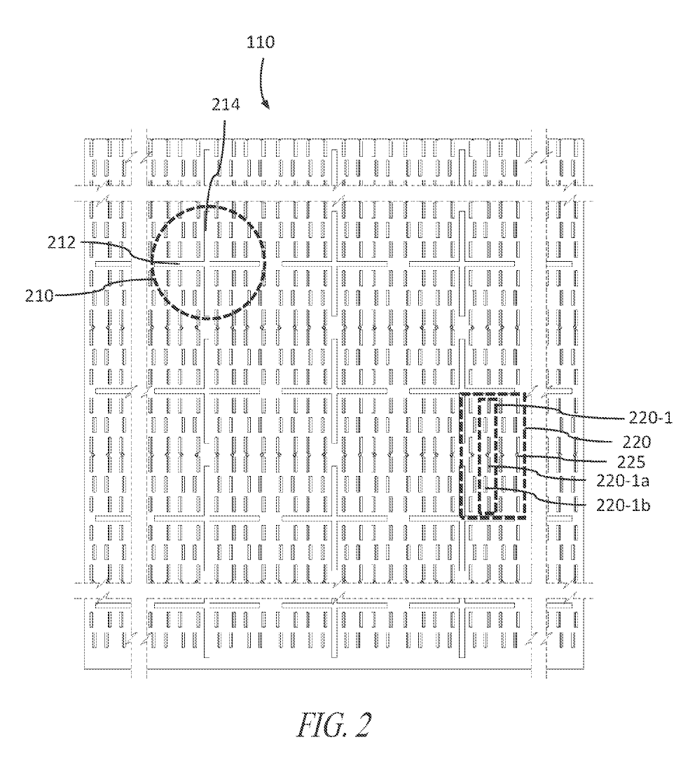

FIG. 2 is a plan view of a portion of first face sheet 110 of efficient planar phase array antenna assembly 100 of FIG. 1. First face sheet 110 comprises a plurality of L-band radiating elements, such as L-band radiating element 210. L-band radiating element 210 comprises an L-band H-polarization slot 212, and an L-band V-polarization slot 214.

First face sheet 110 further comprises a plurality of X-band radiating elements such as X-band radiating element 220. X-band radiating element 220 comprises one or more X-band waveguides. In the example shown in FIG. 2. X-band element comprises four X-band waveguides, such as X-band waveguide 220-1. X-band waveguide 220-1 comprises a plurality of X-band slots. In the example shown, X-band waveguide 220-1 comprises six slots, for example X-band slots 220-1a and 220-1b. X-band waveguide 220-1 further comprises X-band feed 225.

The length of X-band slots, such as X-band slots 220-1a and 220-1b, determines, at least in part, the resonant frequency of antenna assembly 100. The offset of each X-band slot (such as X-band slots 220-1a and 220-1b) from the center line of the X-band waveguide (such as X-band waveguide 220-1), at least in part, defines the radiation efficiency.

Since the X-bands slots belonging to adjacent X-band waveguides are offset in opposite directions from the center line of the respective waveguide, the feeds are configured to be 180° out of phase with each other, so that radiation emitted from adjacent waveguides is in phase.

The spacing between each X-band element and between each L-band element can be selected to eliminate, or at least reduce, the effect of grating lobes and scan blindness (loss of gain at one or more scan angles).

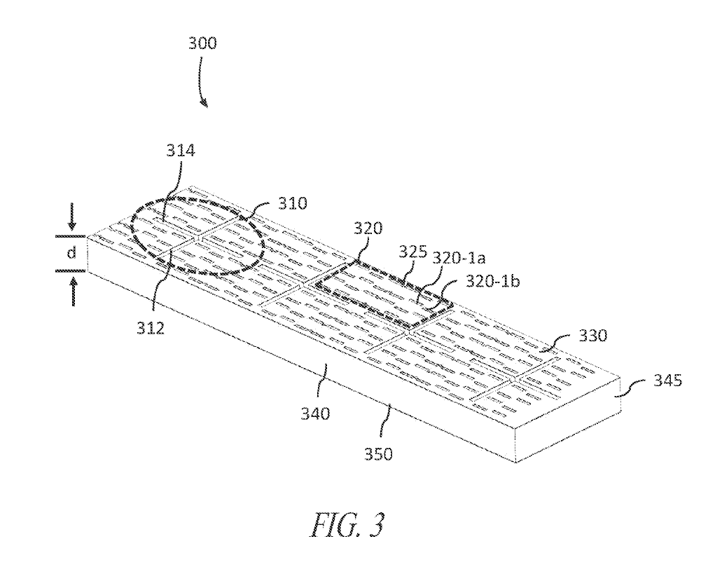

FIG. 3 is an isometric view of a microwave subarray 300 of the efficient planar phase array antenna assembly of FIG. 1. Microwave subarray 300 comprises radiating elements 310 and 320 for L-band and X-band, respectively. Microwave subarray 300 further comprises L-band and X-band feeds and feed housings (not shown in FIG. 3).

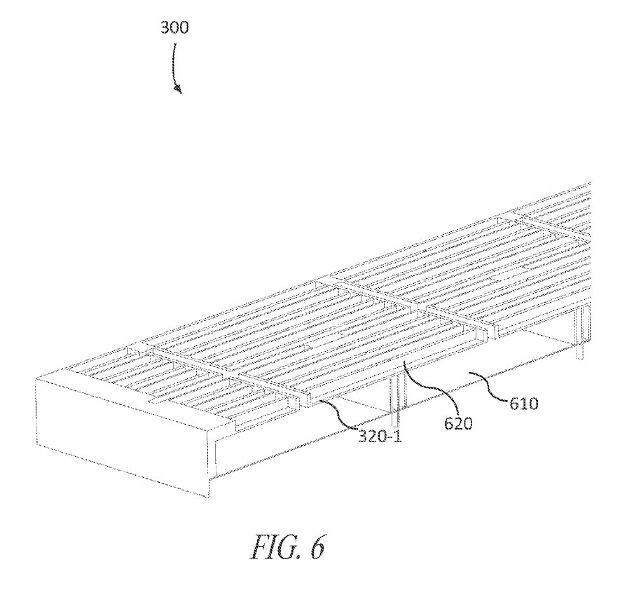

L-band radiating element has a crossed slot for horizontal and vertical polarizations, and a backing cavity. The use of a resonant cavity behind the aperture as shown in FIG. 6 reduces the depth required for the slot antenna. The volumes around the crossed L-band slot can be used for X-band radiating elements as described below.

L-band radiating element 310 comprises an L-band H-polarization slot 312 and an L-band V-polarization slot 314. X-band radiating element 320 comprises four waveguides, each waveguide comprising a plurality of slots such as 320-1a and 320-1b.

In an example implementation, the space between the first face sheet and the cavity is about 15 mm thick. This is thick enough to fit an X-band waveguide radiating from its broad dimension. Waveguide implementation of the X-band elements is an attractive option because it is low-loss and increases the efficiency of the antenna.

The space between L-band slots can accommodate more than one X-band waveguide radiator. One implementation uses a ridged waveguide to increase bandwidth at the expense of higher attenuation and lower power-handling capability. The ridged waveguide can be fed at the centre. The X-band radiators can be fed by probe excitation or by loop-coupled excitation of the waveguide.

As shown in FIG. 3, the L-band crossed slots form boundaries around the X-band radiating elements. In one embodiment, two sets of four X-band ridged waveguides can fit between each pair of L-band crossed slots. In another embodiment, with different gain requirements, a single set of four X-band ridged waveguides is positioned between each pair of L-band crossed slots.

Microwave subarray 300 further comprises top face sheet 330, side sheet 340, end sheet 345, and bottom face sheet 350. Bottom face sheet 350 is a ground plane and reflector for the L-band radiating elements. Thickness d of microwave subarray 300 is frequency dependent. Thickness d corresponds to the depth of the L-band cavity (shown in FIG. 6) and would typically be λ/4 for a slot antenna, where A is the L-band wavelength. As described in more detail below, thickness d of microwave subarray 300 can be smaller than λ/4 by using a folded L-band cavity.

The ideal slot antenna is λ/4 deep, and comprises a slot, rather than a slot with an opening into an associated cavity. At L-band wavelengths, the depth of the slot (which drives the thickness of the antenna assembly) would be approximately 6 cm. It is desirable to reduce the thickness of the antenna assembly, to leave room for feeds and electronics, and to meet requirements on antenna dimensions such as those imposed by launch vehicle dimensions.

Simply reducing the depth of the L-band slot would result in an antenna that is difficult to match. The antenna would have low impedance, owing to the presence of the electrically conductive wall near the feed and near the radiating slot.

The technology described in this application comprises a resonant cavity behind the aperture. Conceptually, each L-band slot is first bifurcated and then each bifurcation gradually turned to the side so that it forms a “T”. The cross-piece of the “T” lies under the area of the antenna subassembly top face sheet occupied by the L-Band radiating element. In implementation, each L-band slot opens into an L-band cavity (as shown in FIG. 6).

In order for the slot to radiate efficiently, it requires a surrounding conductive surface to support the currents. A number of X-band radiating elements can be placed in the area of the microwave subarray surrounding the L-band slots.

In one embodiment, the L-band feed can be implemented in low-loss substrate material placed at the side of the microwave subarray, with probes across the L-band slots. Since, in this embodiment, the L-band feed housings are along the side of microwave subarray 300, they can act as stiffeners for the microwave subarray.

In another embodiment, the L-band feed can be implemented using stripline between the slots and the cavities. This is described in more detail below.

The number of microwave subarrays is selected to achieve the desired gain, coverage and target resolution for its intended purpose.

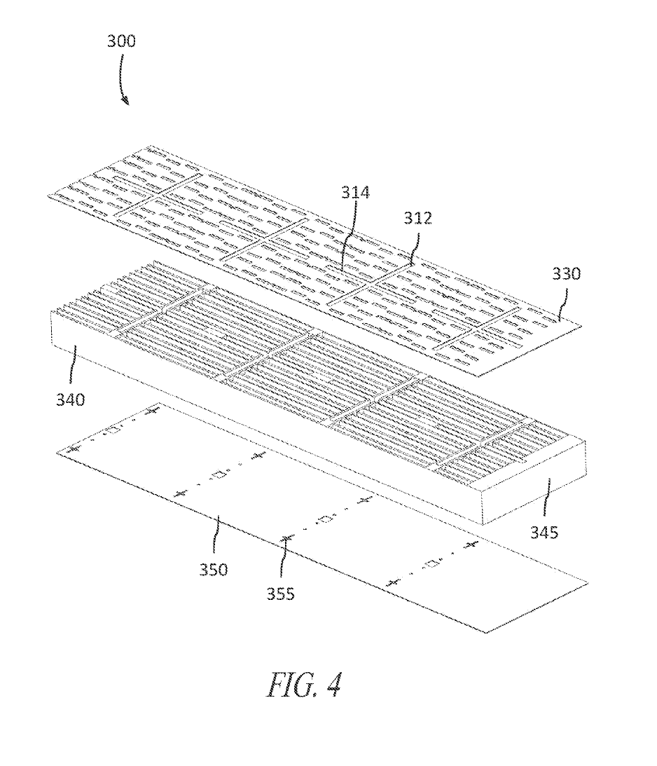

FIG. 4 is an exploded view of microwave subarray 300 of FIG. 3. Microwave subarray 300 comprises top face sheet 330, side sheet 340, end sheet 345, and bottom face sheet 350. Bottom face sheet 350 covers the bottom of the L-band cavities and comprises slots 355 for X-band feeds.

Microwave subarray 300 comprises L-band H-polarization and V-polarization slots 312 and 314, respectively. Microwave subarray comprises X-band waveguides, such as waveguide 320-1. In some embodiments, such as the embodiment illustrated in FIG. 4, waveguide 320-1 is a ridged waveguide.

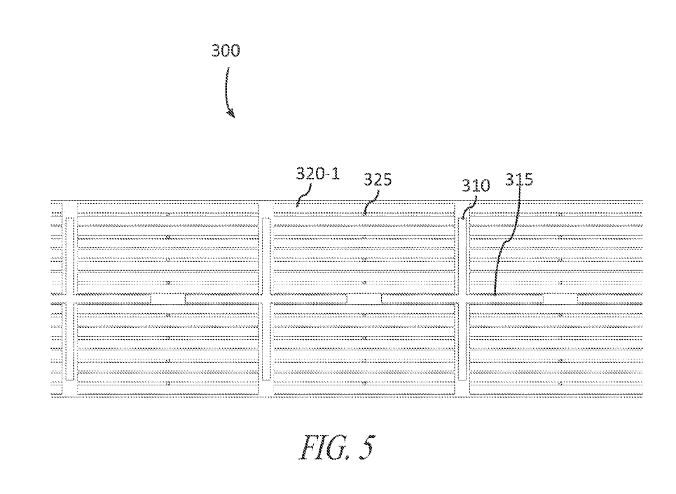

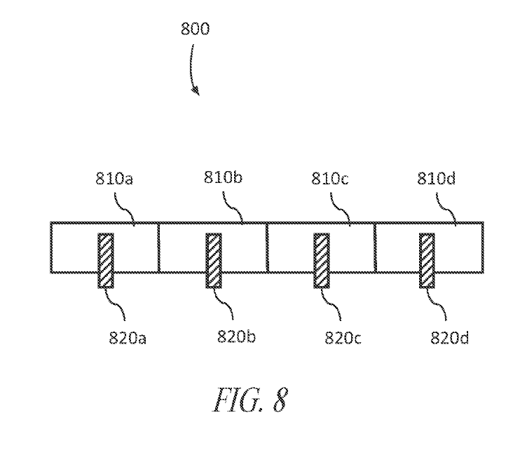

FIG. 5 is a close-up of a plan view of microwave subarray 300 of FIG. 3 with top face sheet 330 removed. Microwave subarray 300 comprises L-band H-polarization and V-polarization slots 312 and 314, respectively. Microwave subarray comprises X-band waveguides, such as ridged waveguide 320-1. Microwave subarray 300 further comprises a plurality of X-band feeds, such as X-band feed 325. X-band feed 325 is described in more detail with reference to FIG. 8.

FIG. 6 is an isometric view of a close-up of microwave subarray 300 of FIG. 3 with side sheet 340 removed to show the L-band cavities.

The dimensions of L-band cavity 610 is frequency dependent. The depth of L-band cavity 610 is selected to provide high radiation efficiency while maintaining compact size. Similarly, the dimensions of the X-band waveguides, such as X-band waveguide 320-1, determine, at least in part, the resonant frequency and the bandwidth. X-band waveguide 320-1 comprises ridge 620.

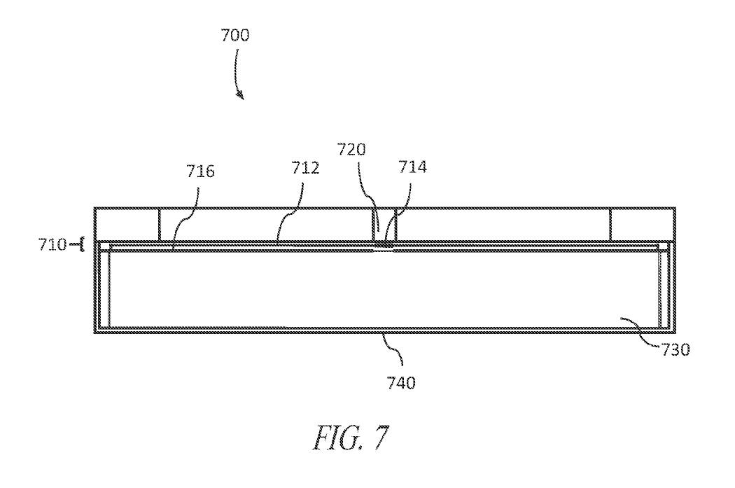

FIG. 7 is a cross-section of L-Band radiating element 700 illustrating L-band feed network 710. L-band radiating element 700 comprises L-band slot 720, cavity 730, and reflector 740. L-band feed network 710 comprises stripline 712, probe 714, and ground plane 716.

L-band feed network 710 comprises a matching network (not shown in FIG. 7) embedded in stripline 712 to facilitate matching of impedance across the bandwidth.

L-band slot 720 comprises two probes, 180° out of phase with each other. The locations of the two probes in slot 720 are selected to achieve a desired radiation efficiency. Hi-polarization and V-polarization L-band slots can be fed independently. H and V polarized pulses can be transmitted at the same time.

Stripline 712 ends with probe 714 across slot 720, the probe operable to excite a field in slot 720.

L-band feed network 710 can comprise a shield (not shown in FIG. 7) to suppress cross-polarization. In an example implementation. L-band feed network is configured to suppress cross-polarization by 60 dB.

FIG. 8 is a cross-section of X-band radiating element 800 illustrating an X-band feed network 820. X-band radiating element 800 comprises four waveguides 810a. 810b, 810c, and 810d. Waveguides 810a, 810b. 810c, and 810d are ridged waveguides and have a ridge inside the waveguide. The dimensions of the ridge determine, at least in part, power transfer, matching and bandwidth. A benefit of a ridge in the waveguide is higher gain for equivalent radiation efficiency. Waveguides comprising a ridge can be smaller than equivalent waveguides without a ridge, and more ridged waveguides can be packed into an equivalent volume.

X-band feed network 820 comprises four coaxial cables 820a, 820b, 820c, and 820d, one for each of waveguides 810a. 810b, 810c, and 810d. Each waveguide is fed by its corresponding coaxial cable, the inner conductor of the cable (not shown in FIG. 8) passing through an aperture in the ridge to make contact with the top wall of the waveguide.

The feed coaxial cable is communicatively coupled to feed the radiating slots with the amplitude and phase signals required to create directional beams, and to perform beam scanning. In the example shown in FIG. 8, two adjacent coaxial cables are 180° out of phase.

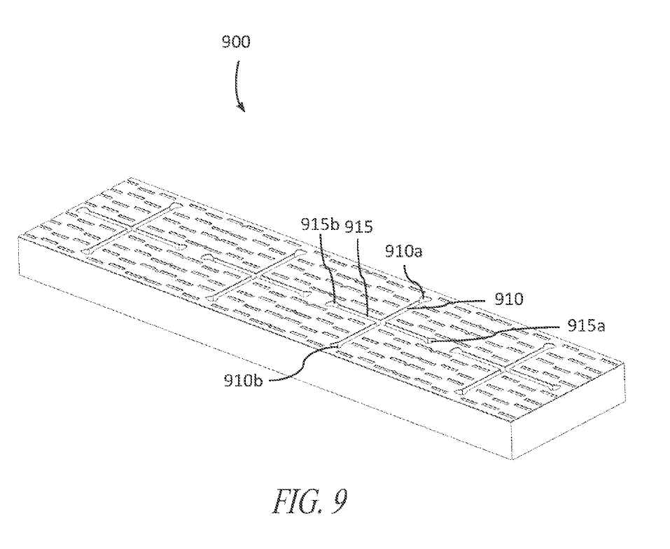

FIG. 9 is an isometric view of microwave subarray 900 of a second embodiment of an efficient planar phase array antenna assembly. Microwave subarray 900 comprises pairs of crossed L-band slots, such as slots 910 and 915, for H-polarization and V-polarization, respectively. In plan view, in FIG. 2 through FIG. 7, the L-band slots (such as slots 310 and 315) have a rectangular shape. In the embodiment shown in FIG. 9, slots 910 and 915 have rounded ends 910a and 910b, and 915a and 915b, respectively.

While FIG. 9 shows rounded ends, other suitable shaping can be used for the slot ends. Moreover, a portion, or the entire length, of each slot can be shaped or tapered, for example by providing a linear or exponential tapering of each slot from the middle towards each end. A benefit of shaped slots is improved tuning of resonant frequency and an increase in bandwidth.

A similar benefit can be achieved by flaring the vertical walls of the L-band slot. The cross-sectional profile of an L-band slot can be shaped to achieve a desired resonant frequency and bandwidth. In one implementation, the sides of the L-band slot are vertical. In another implementation, the sides of the L-band slot are tapered from the top of the slot to the bottom of the slot in a linear fashion. In yet another implementation, the sides of the L-band slot are tapered from the top of the slot to the bottom of the slot according to a portion of an exponential curve. In other implementations, other suitable tapering can be used.

In some implementations, shaping of the slot and its cross-sectional profile are combined to achieve a desired frequency and bandwidth.

L-band slots can be partially or fully filled with a material, for example a low-loss dielectric, to modulate the electrical length of the slot to achieve a desired resonant frequency without changing the physical length of the slot.

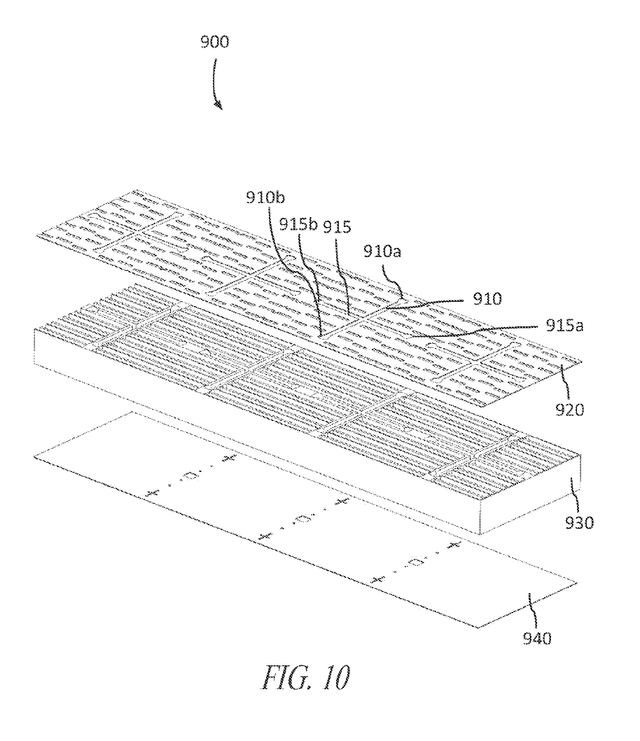

FIG. 10 is an exploded view of the microwave subarray of FIG. 9.

FIG. 11 is an isometric view of a close-up of the microwave subarray of FIG. 9 with the side removed to show the L-band cavity.

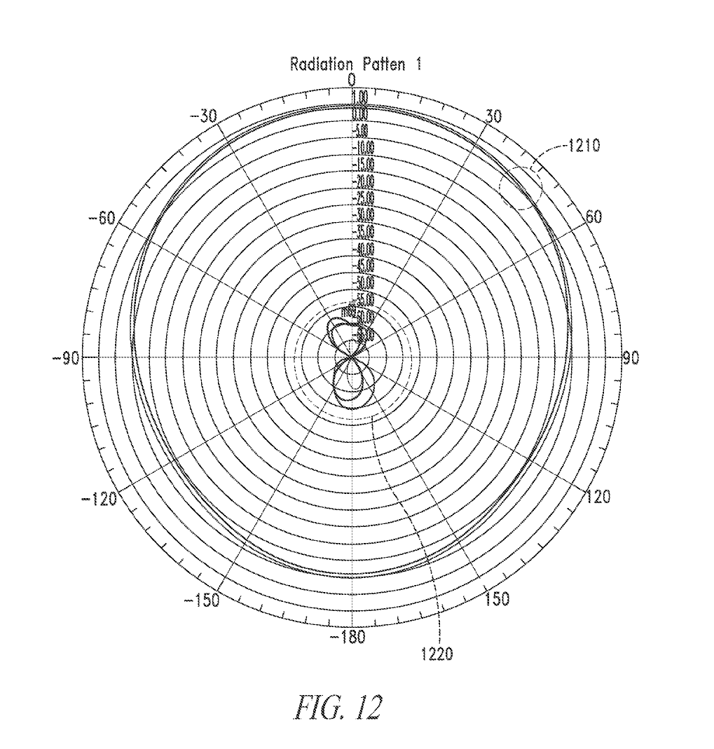

FIG. 12 is a polar plot showing the gain for an L-band radiating element of the efficient planar phase array antenna assembly of FIG. 9. In the example shown, a co-polarization to cross-polarization isolation ratio of at least 60 dB is achieved for across the range of elevation angles. Circle 1210 indicates the co-polarization gain graphs for three frequencies. Circle 1220 indicates the cross-polarization gain graphs for the same three frequencies.

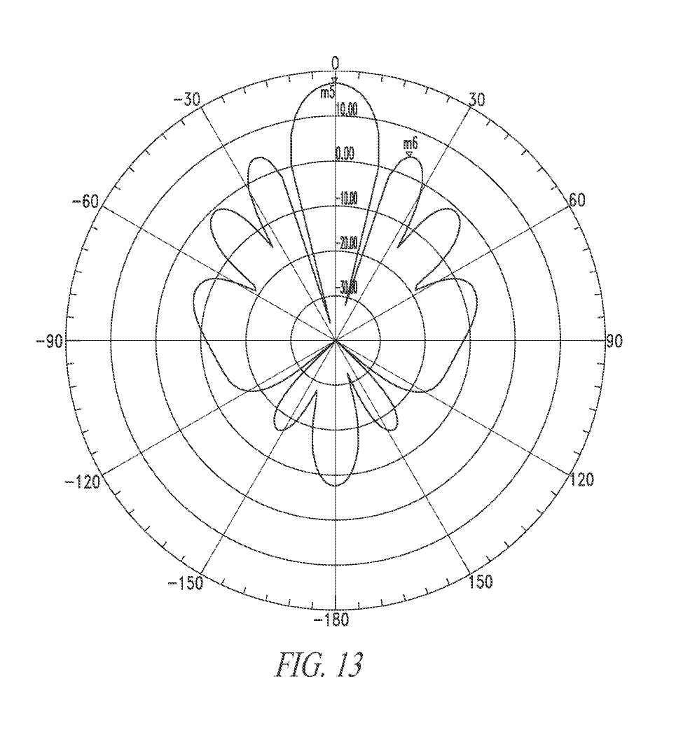

FIG. 13 is a polar plot showing the gain for an X-band radiating element of the efficient planar phase array antenna assembly of FIG. 9. In the example shown, a peak gain of at least 18 dB was achieved.

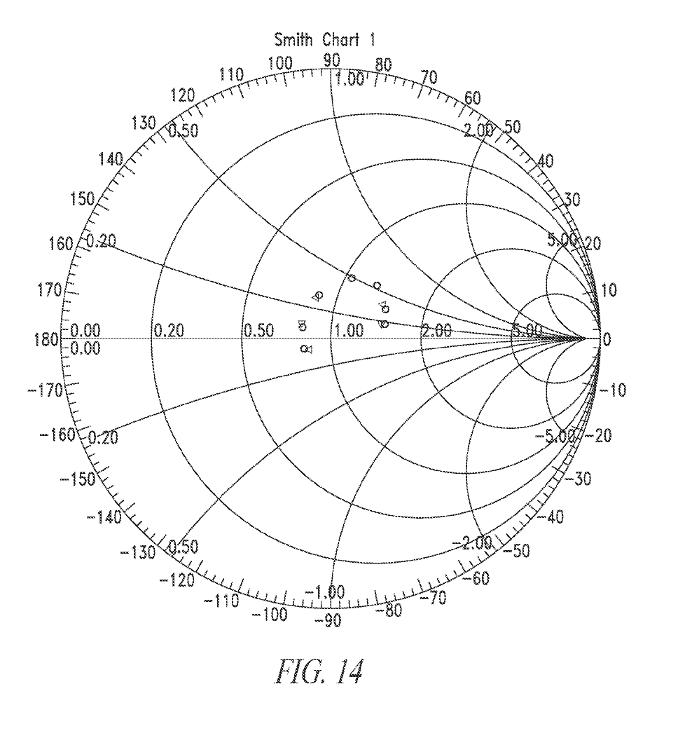

FIG. 14 is an impedance Smith chart for an L-band radiating element of the efficient planar phase array antenna assembly of FIG. 9.

Benefits of the antenna technology described above include greater mass efficiency and greater radiating efficiency. Simulations have demonstrated that a radiation efficiency of over 80% can be achieved across the frequency band for X-band and L-band radiating elements, including all losses.

Having the radiating elements of the antenna be self-supporting makes the design mass efficient. No additional structural mass is needed. All the metal in the antenna performs two functions for the antenna—firstly to provide the slots and cavities for the radiating elements, and secondly to provide the structural integrity. Since the antenna can be constructed entirely from metal, there are no dielectric materials contributing to losses in the antenna, and the radiating efficiency of the antenna is high. The only losses are surface metal losses.

The above description of illustrated embodiments, including what is described in the Abstract, is not intended to be exhaustive or to limit the various embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other imaging systems, not necessarily the exemplary satellite imaging systems generally described above.

While the foregoing description refers, for the most part, to satellite platforms for SAR and optical sensors, remotely sensed imagery can be acquired using airborne sensors including, but not limited to, aircraft and drones. The technology described in this disclosure can be applied to imagery acquired from sensors on spaceborne and airborne platforms.

The various embodiments described above can be combined to provide further embodiments. U.S. Provisional Patent Application Ser. No. 62/137,934, filed Mar. 25, 2015 (Atty. Docket No. 920140.404P1) U.S. Provisional Patent Application Ser. No. 62/180,421, filed Jun. 16, 2015 and entitled “EFFICIENT PLANAR PHASED ARRAY ANTENNA ASSEMBLY” (Atty. Docket No. 920140.405P1); U.S. Provisional Patent Application Ser. No. 62/180,449, filed Jun. 16, 2015 and entitled “SYSTEMS AND METHODS FOR ENHANCING SYNTHETIC APERTURE RADAR IMAGERY” (Atty. Docket No. 920140.407P1); and U.S. Provisional Patent Application Ser. No. 62/180,440, filed Jun. 16, 2015 and entitled “SYSTEMS AND METHODS FOR REMOTE SENSING OF THE EARTH FROM SPACE” (Atty. Docket No. 920140.406P1), are each incorporated herein by reference, in their entirety. Aspects of the embodiments can be modified, if necessary, to employ systems, circuits and concepts of the various patents, applications and publications to provide yet further embodiments.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of signal hearing media used to actually carry out the distribution. Examples of signal hearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

These and other changes can be made in light of the above-detailed description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure.

1. A planar phased array antenna assembly comprising:
a first face sheet, the first face sheet comprising a first plurality of radiating slots for a first frequency band and a second plurality of radiating slots for a second frequency band;
a second face sheet;
a structure interposed between the first face sheet and the second face sheet, the structure comprising a third plurality of radiating elements at the first frequency band and a fourth plurality of radiating elements at the second frequency band, the structure further comprising a first feed network for the third plurality of radiating elements and a second feed network for the fourth plurality of radiating elements; and
a third face sheet wherein the second face sheet is interposed between the structure and the third face sheet.

2. The planar phased array antenna assembly of claim 1 wherein the assembly is structurally self-supporting.

3. The planar phased array antenna assembly of claim 2 wherein substantially the entire assembly consists of radiating elements and feed networks.

4. The planar phased array antenna assembly of claim 1 wherein the first face sheet, the second face sheet, the third face sheet, and the structure each comprise machined aluminium.

5. The planar phased array antenna assembly of claim 1 wherein each of the third plurality of radiating elements comprises a folded cavity coupled to at least one of the first plurality of radiating slots.

6. The planar phased array antenna assembly of claim 1 wherein each of the fourth plurality of radiating elements comprises at least one waveguide coupled to at least one of the second plurality of radiating slots, and the third face sheet comprises waveguide terminations.

7. The planar phased array antenna assembly of claim 6 wherein each of the at least one waveguide is a ridged waveguide.

8. The planar phased array antenna assembly of claim 1 wherein the first frequency band is L-band and the second frequency band is X-band.

9. The planar phased array antenna assembly of claim 1 wherein the first feed network comprises at least one stripline, and at least one probe coupled to each of the third plurality of radiating elements.

10. The planar phased array antenna assembly of claim 1 wherein the second feed network comprises at least one coaxial cable coupled to each of the fourth plurality of radiating elements.

11. The planar phased array antenna assembly of claim 1 wherein the first plurality of radiating slots comprise a plurality of crossed slots, the crossed slots operable to radiate horizontally polarized and vertically polarized microwaves.

12. The planar phased array antenna assembly of claim 11 wherein the plurality of crossed slots are flared in at least one of an in-plane and a through-plane orientation.

13. The planar phased array antenna assembly of claim 5 wherein the folded cavity is at least partially filled with dielectric material.

14. The planar phased array antenna assembly of claim 2 wherein the first, the second and the third face sheets and the structure interposed between the first and the second face sheets comprise a sole support structure of the planar phased array antenna assembly that self supports the planar phased array antenna assembly without any additional structure.

15. A synthetic aperture radar (SAR) antenna comprising a planar phased array antenna assembly, the planar phased array antenna assembly comprising:
a first face sheet, the first face sheet comprising a first plurality of radiating slots for a first frequency band and a second plurality of radiating slots for a second frequency band;
a second face sheet;
a structure interposed between the first face sheet and the second face sheet, the structure comprising a third plurality of radiating elements at the first frequency band and a fourth plurality of radiating elements at the second frequency band, the structure further comprising a first feed network for the third plurality of radiating elements and a second feed network for the fourth plurality of radiating elements; and
a third face sheet wherein the second face sheet is interposed between the structure and the third face sheet.

16. The synthetic aperture radar (SAR) antenna of claim wherein the planar phased array antenna assembly is structurally self-supporting.

17.-28. (canceled)

29. The planar phase array antenna assembly of claim 1 wherein the first frequency band is lower than the second frequency band.

30. The planar phase array antenna assembly of claim 29 wherein the first face sheet further comprises a fifth plurality of radiating slots for a third frequency band, the structure further comprises a sixth plurality of radiating elements at a third frequency band, the third frequency band higher than the first frequency band and lower than the second frequency band.

31. The synthetic aperture radar (SAR) antenna of claim 15 wherein the first frequency band is lower than the second frequency band.

32. The synthetic aperture radar (SAR) antenna of claim 16 wherein the first, the second and the third face sheets and the structure interposed between the first and the second face sheets comprise a sole support structure of the planar phased array antenna assembly that self supports the planar phased array antenna assembly without any additional structure.

33. A synthetic aperture radar (SAR) comprising a planar phased array antenna assembly, the planar phased array antenna assembly comprising:
a first face sheet, the first face sheet comprising a first plurality of radiating slots for a first frequency band and a second plurality of radiating slots for a second frequency band;
a second face sheet;
a structure interposed between the first face sheet and the second face sheet, the structure comprising a third plurality of radiating elements at the first frequency band and a fourth plurality of radiating elements at the second frequency band, the structure further comprising a first feed network for the third plurality of radiating elements and a second feed network for the fourth plurality of radiating elements; and
a third face sheet wherein the second face sheet is interposed between the structure and the third face sheet.

34. The synthetic aperture radar (SAR) of claim 33 wherein the planar phased array antenna assembly is structurally self-supporting.

35. The synthetic aperture radar (SAR) of claim 34 wherein the first, the second and the third face sheets and the structure interposed between the first and the second face sheets comprise a sole support structure of the planar phased array antenna assembly that self supports the planar phased array antenna assembly without any additional structure.

36. The synthetic aperture radar (SAR) of claim 33 wherein the first frequency band is lower than the second frequency band.
